(19) United States
(12) Patent Application Publication
(10) Pub. No.: US 2011/0238387 A1
(43) Pub. Date: Sep. 29, 2011

(54) APPARATUS AND COMPUTER PROGRAM FOR GENERATING ROUTE

(76) Inventors: Toshiyuki MIYAKE, Hitachi (JP); Ichiro Harashima, Hitachiota (JP); Koji Shiroyama, Mito (JP); Masatake Sato, Tokai (JP); Yuhiro Yoshida, Hitachi (JP)

(21) Appl. No.: 13/038,486

(22) Filed: Mar. 2, 2011

(30) Foreign Application Priority Data
Mar. 2, 2010 (JP) 2010-044883

(51) Int. Cl. G06F 17/50

(52) U.S. Cl. 703/1

(57) ABSTRACT

A route generating apparatus includes: storage section storing geometric data of connection objects; data representing connection relations of group of main route for directly connecting objects, and branch route branching from main route, and connection objects; and data representing each constraint condition for constraining disposition position of branch point on the main route; constraint region generating section that generates each constraint region where corresponding branch point can be disposed, based on the geometric disposition position of corresponding connection object, corresponding connection relation, and corresponding constraint condition; route generating section that generates, as each main route, a shortest main route passing through each constraint region and generates, as each branch route, a shortest branch route that branches from the main route; and constraint region and route display section that displays a geometric figure of each constraint region, each main route, and each branch route.

### CROSS REFERENCE TO RELATED APPLICATIONS

The present application claims benefit of the filing date of Japanese Patent Application No. 2010-044883 filed on Mar. 2, 2010.

### BACKGROUND OF THE INVENTION

1. Field of the Invention

The present invention relates to a technique that aids route designing using a CAD (Computer Aided Design), and particularly relates to a technique for generating piping routes to connect units and the like.

2. Description of the Related Art

In piping designing for connecting units in various plants or wiring designing for connecting parts of electronic circuits, in order to design connection routes between connection objects, CAD (Computer Aided Design) devices are used. In general, a maze algorithm is widely used as a method for automatically searching connection routes to be designed.

As a conventional method, JP 07-036192 B proposes a method for determining disposition routes. In the method, the disposition design, the disposition reference, and the disposition environment of plant piping and units are input; route search is performed by a method for route search, such as an existing maze algorithm, to individually search routes of plural groups of piping, ignoring the interference between piping and units; and then disposition routes are determined, based on the disposition reference, avoiding interference with obstacles.

### SUMMARY OF THE INVENTION

In the proposal by JP 07-036192 B, only a result of generation of routes satisfying the disposition reference is displayed as output, and accordingly, a designer cannot confirm whether the routes satisfy the disposition reference during designing. Consequently, re-designing may be required if individual disposition references conflict with each other.

Further, according to the proposal by JP 07-036192 B, it is necessary to designate branch points of a plurality of branch routes connected to a main route as pass points of on the route, which causes a problem of requiring a lot of work to generate routes in route designing, such as plant piping including a number of main routes and branch routes.

In order to solve the above-described problems, an object of the present invention is to efficiently perform route designing with a number of main routes and branch routes while a designer confirms whether disposition references for routes are satisfied.

In order to achieve the above-described object, according to the present invention, a route generating apparatus for generating routes that connect connection objects includes a storage section that stores: geometric disposition data of connection objects; connection relation data that represents connection relations of a group of main route for directly connecting connection objects, and branch route branching from a main route and connects with a connection object and the main route, and the connection objects; and design constraint data which represents each constraint condition for constraining a disposition position of a branch point where the corresponding branch route branches from the corresponding main route. Further, the route generating apparatus includes: a constraint region generating section that reads out the disposition data, the connection relation data, and the design constraint data, and generates constraint region data which represents, for the each branch route, a constraint region where the corresponding branch point can be disposed, based on the disposition position of the corresponding connection object represented by the disposition data, the corresponding connection relation between the connection object, the main route, and the branch route represented by the connection relation data, and the corresponding constraint condition between the branch point and the connection object represented by the design constraint data; a route generating section that reads out the constraint region data and generates, as the each main route, a shortest main route passing through the each constraint region corresponding to the each branch route connected with the main route, and generates, as the each branch route, a shortest branch route that branches from the main route; and a constraint region and route display section that reads out the constraint region data and displays a geometric figure representing the each constraint region of the constraint region data and a geometric figure representing the each main route and the each branch route, superimposing the geometric figures or individually.

Further, according to the invention, in the route generating apparatus, the constraint region and route display section displays the geometric figure of the each constraint region in the constraint region data where the corresponding branch point can be disposed, superimposing the geometric figure on the geometric figure of the disposition data.

Still further, according to the invention, the route generating apparatus includes an edit section for editing the each route generated by the route generating section, and the each constraint condition in the constraint region data between the each branch point and the disposition position of the each connection object, wherein the constraint region and route display section displays a geometric figure of the each constraint region as a result of editing by the edit section, superimposing the geometric figures on the geometric figure of the disposition data.

Details will be described later.

### BRIEF DESCRIPTION OF THE DRAWINGS

FIG. 1 is an illustration showing a configuration of a route generating apparatus in one embodiment according to the present invention;

FIGS. 2A and 2B are illustrations showing an example of disposition data;

FIGS. 3A and 3B are illustrations showing an example of connection relation data;

FIGS. 4A to 4C are illustrations showing an example of design constraint data;

FIGS. 5A and 5B are illustrations showing an example of constraint region data;

FIG. 6 is an illustration showing an entire process flow in the one embodiment according to the invention;

FIG. 7 is an illustration showing a process flow for generating constraint region data in the one embodiment according to the invention;

FIG. 8 is an illustration showing a process flow for generating main routes and branch routes in the one embodiment according to the invention;

FIG. 9 is an illustration showing a process flow for displaying routes and constraint regions in the one embodiment according to the invention;

FIG. 10 is an illustration showing a display example of routes in the one embodiment according to the invention;

FIG. 11 is an illustration showing a display example of constraint regions in the one embodiment according to the invention;

FIG. 12 is an illustration showing another display example of constraint regions in the one embodiment according to the invention;

FIG. 13 is an illustration showing a configuration of a route generating apparatus in another embodiment according to the invention;

FIG. 14 is an illustration showing a display example of an edit screen for routes; and

FIG. 15 is an illustration showing a display example of an edit screen for constraint regions.

### DETAILED DESCRIPTION OF THE PREFERRED EMBODIMENT

Referring to the drawings, one embodiment according to the present invention will be described below. In addition, the same reference symbols are assigned to the same elements throughout the drawings.

### First Embodiment

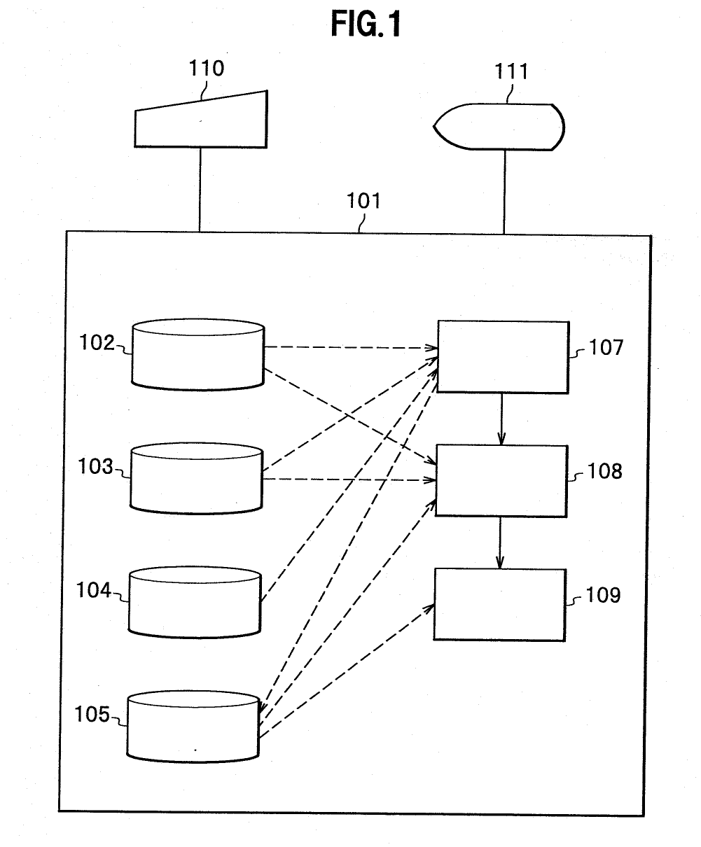

FIG. 1 shows a configuration of a route generating apparatus in one embodiment according to the present invention. A route generating apparatus 101 in the present embodiment has a software configuration, implemented on a computer, including a disposition database 102, a connection relation database 103, a design constraint database 104, a constraint region database 105, a constraint region generating section 107, a route generating section 108, a constraint region and route display section 109, and the like. The route generating apparatus 101 is communicably connected with a hardware configuration including an input device 110, an output unit (display unit) 111, and the like. Incidentally, the route generating apparatus 101 has a hardware configuration, not shown, including a control device (for example, a CPU (Central Processing Unit)), a storage unit (for example, a ROM (Read Only Memory), a RAM (Random Access Memory: storage area), an HDD (Hard Disk Drive), and the like, wherein, for example, the control device reads out a program according to the software configuration and stored in the storage unit into the storage area, and executes a code described in the program to realize corresponding information processing. Further, the route generating apparatus 101 may include the input device 110 and the output unit 111.

The disposition database 102 is used to store disposition data including geometrical information, such as the shapes, the disposition positions, the directions and the like of connection objects (for example, units of a plant). For application to piping routes of a plant or the like, the disposition data becomes, for example, three-dimensional CAD data including information on the three dimensional shapes of units, which become connection objects, and information on the shapes, the disposition coordinate values, and the direction vectors of unit nozzles, which become parts to be connected with pipes. Further, for application to wiring routes of electronic circuits or the like, the disposition data may be, for example, two-dimensional CAD data including information on the two-dimensional shapes, the disposition coordinate values, and the direction vectors of terminals to be connected with electronic parts, which become connection objects, and wires.

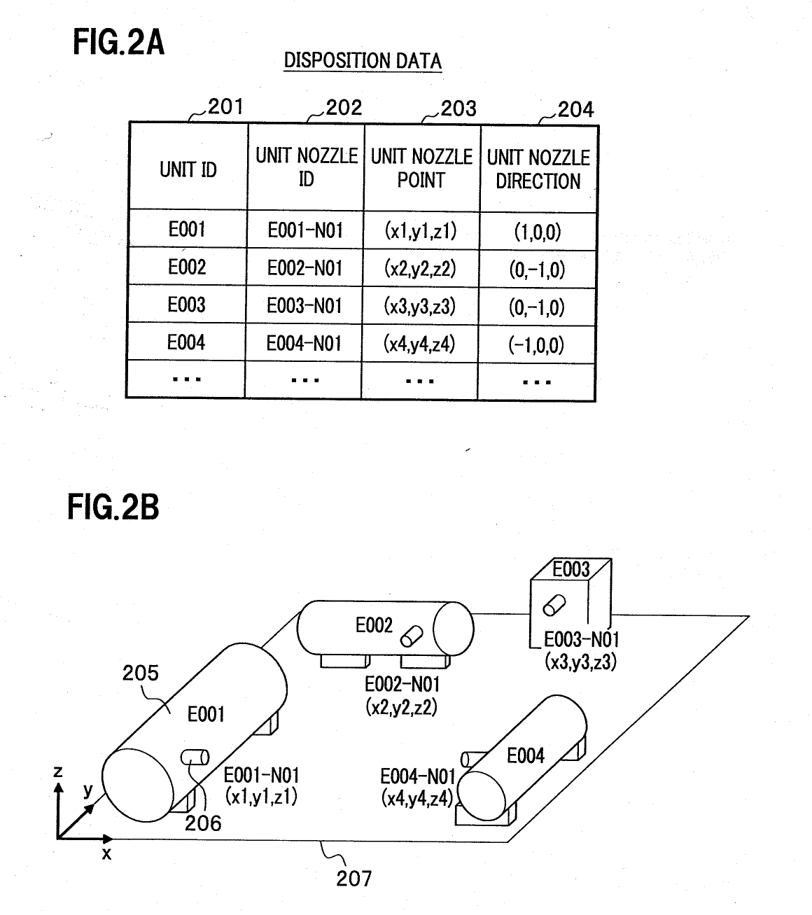

FIGS. 2A and 2B show an example of disposition data. This disposition data is assumed to be represented by three-dimensional CAD data. As shown in FIG. 2A, this disposition data as three-dimensional CAD data includes groups each of which includes a unit ID 201 with a registered identifier for identifying a unit, a unit nozzle ID 202 with a registered identifier for identifying the nozzle fitted to the unit, a unit nozzle point 203 with registered three-dimensional coordinate values of the nozzle, and a unit nozzle direction 204 with a registered direction vector showing the direction of extension of the nozzle, for example, as a unit vector.

Further, as shown in FIG. 2B, this disposition data includes unit geometric shape data 205 representing the geometric shapes of units disposed in a three-dimensional space, unit nozzle geometric shape data 206 representing the geometric shapes of the nozzles of the units, and building geometric shape data 207 representing the geometric shapes of the floors, the walls, and the like of a plant building or the like.

The connection relation database 103 is used to store connection relation data representing the connection relations between connection objects.

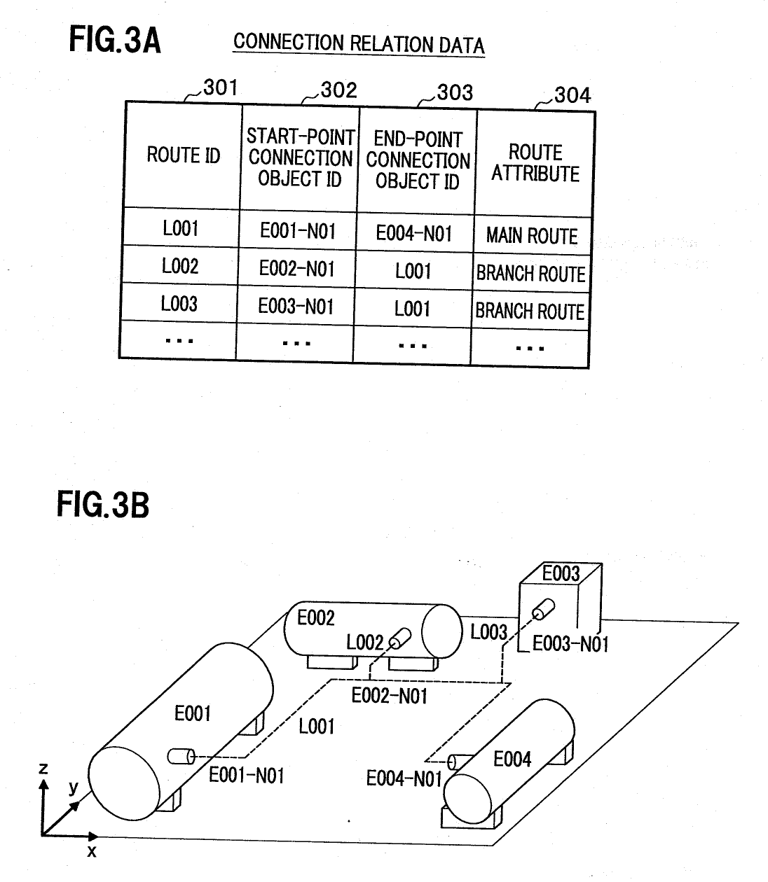

FIGS. 3A and 3B show an example of connection relation data. As shown in FIG. 3A, this connection relation data includes groups each of which includes a route ID 301 with a registered identifier for identifying a piping route that is fitted to a nozzle unit to connect units, a start-point connection object ID 302 with a registered identifier for identifying the nozzle of the unit to be at the start-point of the route, an end-point connection object ID 303 with a registered identifier for identifying the nozzle of the unit to be at the end point of the route, and a route attribute 304 with a registered identifier for representing the attribute of the route.

For application to piping routes of a plant or the like, start-point connection object IDs 302 and end-point connection object IDs 303 are unit nozzle IDs or route IDs to be connected. Route attributes 304 have the identifier of main route or the identifier of branch route. If both the start-point connection object and the end-point connection object of a route are unit nozzle IDs 202, the route is a connection route from a unit to a unit and has the identifier of ‘main route’ as the route attribute 304. If one or both of the start-point connection object and the end-point connection object of a piping route is/are an route ID/IDs 301, the route is a branch route branching from a main route and has the identifier of ‘branch route’ as the route attribute 304.

In the connection relation data as shown in FIG. 3A, for example, for the route with a value L0001 registered as the route ID 301, a unit nozzle ID E001-N01 is stored as the value of the start-point connection object ID 302; a unit nozzle ID E004-N01 is stored as the value of the end-point connection object ID 303; and ‘main route’ is stored as the value of the route attribute 304. Further, for the route with a value L002 registered as the route ID 301, a unit nozzle ID E002-N01 is stored as the value of the start-point connection object ID 302; the route ID L001 is stored as the value of the end-point connection object ID 303; and ‘branch route’ is stored as the value of the route attribute 304. FIG. 3B primarily shows the state that the geometric shapes of the main route (L001) and the branch routes (L002, L003) are added (shown by dashed lines) to the geometric shape of disposition data.

The design constraint database 104 is used to store design constraint data representing constraint in terms of disposition related to the branch points between a main route and a branch route branching from the main route. For example, in piping designing of a plant or the like, a piping route for connection of units as connection objects to be connected with each other is required to be a route that connects the units with the shortest length while avoiding other obstacles in order to reduce the material cost. On the other hand, due to constraints in designing of piping and units, a branch point connecting a main pipe and a branch pipe is required to be disposed in a certain range of distance from a unit connected by the branch pipe, for example, depending on the conditions in temperature and pressure of the fluid flowing from the connected unit, via the connecting branch pipe, to the main pipe.

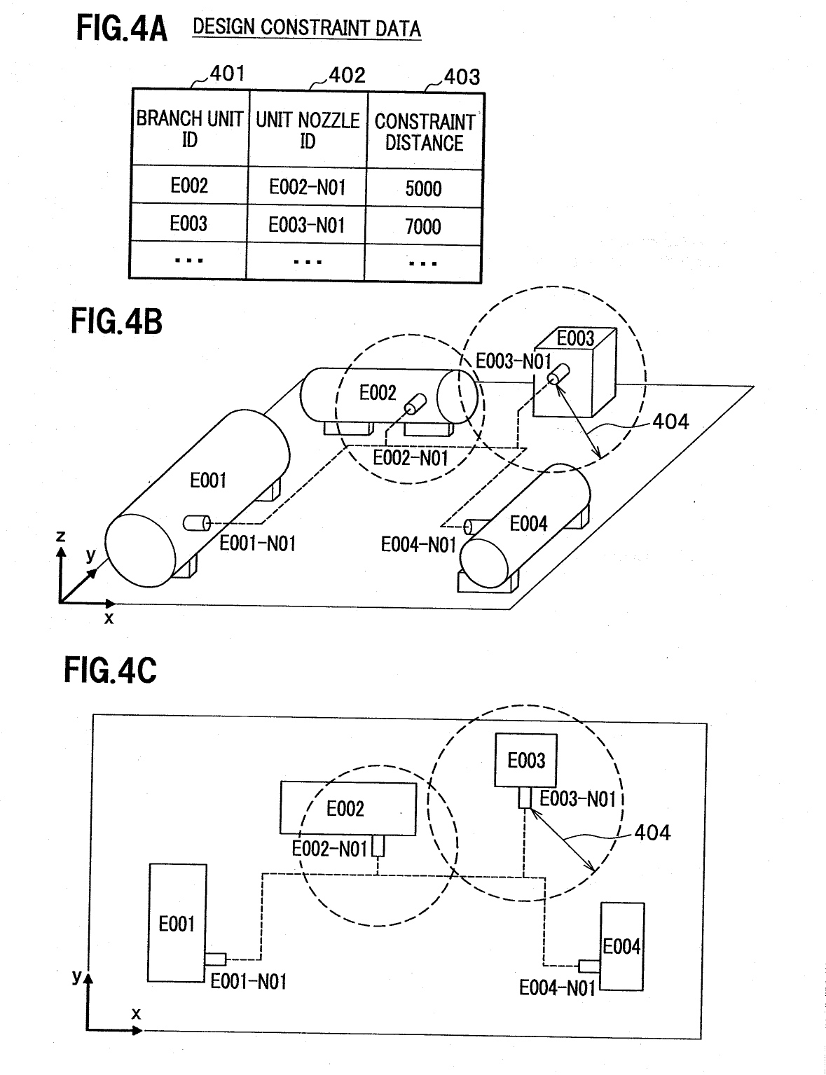

FIGS. 4A and 4B show an example of design constraint data. As shown in FIG. 4A, this design constraint data includes groups each of which includes a branch unit ID 401 with a registered identifier for identifying a branch unit, which is the unit connected by a branch pipe, a unit nozzle ID 402 with a registered identifier for identifying the nozzle of the branch unit, and a constraint distance 403 with a registered distance (unit: mm) from the position of the nozzle of the branch unit.

FIG. 4B primarily shows the state that the geometric shape of design constraining data is added to the geometric shape of disposition data and the geometric shape of connection relation data. This state is shown with spheres (shown by dashed circles) with a center at the position of the nozzle of a unit and a radius (symbol 404) of a value registered as a constraint distance 403. Further, FIG. 4C shows a top view of the geometric shapes viewed from z direction. The top view shows that the branch points between the branch routes and the main route are basically disposed inside these spheres.

The constraint region database 105 is used to store constraint region data representing each passing order that refers to the order in which a main route passes by a plurality of branch units, and regions the main route passes through.

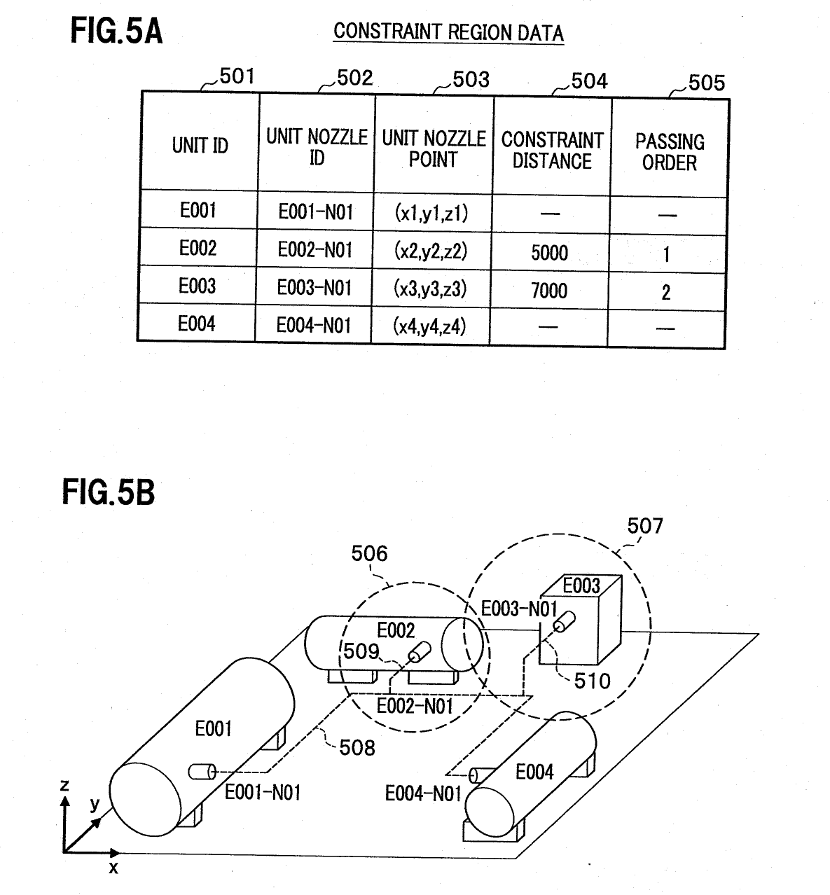

FIGS. 5A and 5B show an example of constraint region data. As shown in FIG. 5A, this constraint region data includes groups each of which includes a unit ID 501 with a registered identifier for identifying a unit, a unit nozzle ID 502 with a registered identifier for identifying a nozzle fitted to the unit, a unit nozzle point (one of the constraint conditions) 503 with registered three-dimensional coordinate values of the nozzle, a constraint distance (one of the constraint conditions) 504 with a registered distance from the position of the nozzle of a branch unit in case that the unit is a branch unit, and a passing order (one of the constraint conditions) 505 with a registered order at which a main route passes through the range of the constraint distance of a branch unit in case that the unit is a branch unit. In case that a unit is not a branch unit, in other words, a unit is one having a nozzle to be the start point or the end point of a main route, the values registered for the constraint distance 504 and the passing order 505 are set blank.

FIG. 5B will be referred to as appropriate in the later description of a process.

The input device 110 is used by a user with a keyboard, a mouse, or the like to perform input or editing of the disposition data, the connection relation data, and design constraint data described above. The output device 111 is used to display, for a user, the output from the route generating section 108 or the constraint region and route display section 109, which will be described later, on the display of a computer or the like.

The constraint region generating section 107 is used to read out the disposition data stored in the disposition database 102, the connection relation data stored in the connection relation database 103, and the design constraint data stored in the design constraint database 104; computes regions that allow disposition of the branch points of branch routes to be connected with a main route; and store a computed result (unit nozzle points 503, constraint distances 504, and the values of passing orders 505) as constraint region data in the constraint region database 105.

The route generating section 108 is used to read out the disposition data stored in the disposition database 102, the connection relation data stored in the connection relation database 103, and the constraint region data stored in the constraint region database 105; and generate the main route that passes through the constraint regions and the branch routes to be connected to the main route.

The constraint region and route display section 109 is used to display the constraint region data stored in the constraint region database 105 and the main route and the branch routes generated by the route generating section 108, as superimposed geometric figures or as individual geometric figures on the output unit 111, such as a computer display.

The process performed by the route generating apparatus in the present embodiment will be described below.

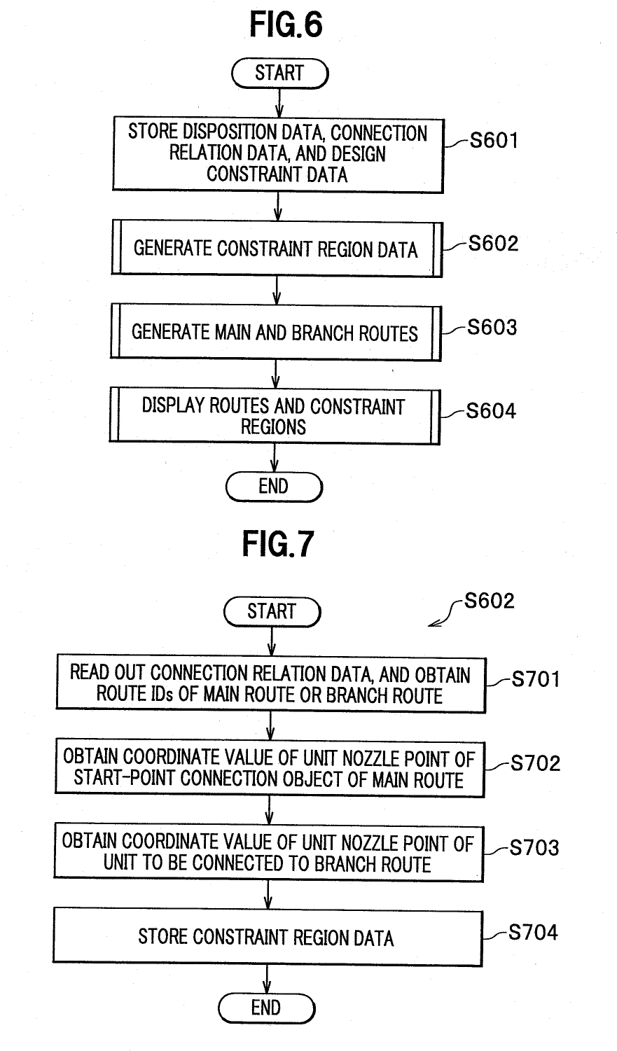

FIG. 6 shows an entire process flow in the one embodiment according to the invention. The process described below is performed mainly by the control section of the route generating apparatus, wherein the control section executes the process to realize the functions of the above-described constraint region generating section 107 and the like.

First, the route generating apparatus 101 stores disposition data, connection relation data, and design constraint data having been input by the user, using the input device 110, such a keyboard or a mouse, respectively into the disposition database 102, the connection relation database 103, and the design constraint database 104 (S601).

The constraint region generating section 107 reads out the disposition data, the connection relation data, and the design constraint data from the respective databases; computes geometric constraint regions that allow disposition of the branch points of branch routes to be connected with a main route; and stores the computed geometric constraint regions as constraint region data into the constraint region database 105 (S602). This process will be described later in detail.

The route generating section 108 reads out the constraint region data from the constraint region database 105, and generates a main and branch routes that satisfy a single or plural constraint regions (S603). This process will be described later in detail.

The constraint region and route display section 109 displays the region figures (spherical shape) of the constraint regions and the route linear figures of the main route and the branch routes, superimposing the figures or individually on the output device 111 (S604). This process will be described later in detail.

The flow of the generation process of the constraint region data by the constraint region generating section 107 (S602) will be described below in detail.

FIG. 7 shows a process flow of generating constraint region data in the one embodiment according to the invention.

The constraint region generating section 107 first reads out connection relation data from the connection relation database 103 (FIG. 3A), and obtains route IDs 301 with a route attribute 304 of main route or branch route (S701). A branch route to be connected with a main route is determined as the start-point connection object ID 302 or the end-point connection object ID 303 of the branch route indicates the route ID of the main route.

From the connection relation data shown in FIG. 3A, L001 is obtained as the route ID of a main route, and L002 and L003 are obtained as the route IDs of the branch routes branching from the main route.

Then, the start-point connection object ID 302 of the main route is read out from the connection relation data, and the unit nozzle ID 202 of the disposition data, as shown in FIG. 2A, is searched by a key of the read-out value of the start-point connection object ID 302 to obtain the coordinate values of the unit nozzle point 203 of the start-point connection object of the main route (S702).

In the disposition data, as shown in FIG. 2A, the unit nozzle ID of the start-point connection object (E0001) of the main route L001 is E001-N01, and (x1, y1, z1) can be obtained as the coordinate values of the unit nozzle point.

Subsequently, the start-point connection object ID 302 of a branch route is read out from the connection relation data (refer to FIG. 3A), and the unit nozzle ID 202 of the disposition data, as shown in FIG. 2A, is searched by a key of the read-out value of the start-point connection object ID 302 to obtain the coordinate values of the unit nozzle point of the unit to be connected to the branch route (S703).

In the disposition data, as shown in FIG. 2A, the unit nozzle ID to be connected to the branch route L002 is E002-N01, and (x2, y2, z2) are obtained as the coordinate values of the unit nozzle point. Further, the unit nozzle ID to be connected to the other branch route L003 is E003-N01, and (x3, y3, z3) can be obtained as the coordinate values of the unit nozzle point.

Based on an order obtained by comparison between the coordinate values of an obtained unit nozzle point and the coordinate values of the unit nozzle point of the start-point connection objects of the main route, the unit nozzle points to be connected with the branch routes are extracted in the order of closer (smaller) distance from the unit nozzle point that is the start-point of the main route. The unit IDs 501, the unit nozzle IDs 502, the unit nozzle points 503, the constraint distances 504, and the passing orders 505 of the constraint region data, as shown in FIG. 5A, are stored into the constraint region database 105 (S704). Herein, the constraint distances 502 are obtained from the constraint distances 403 that are stored in the design constraint database 104 having been input by the user in advance. In general, the orders to be registered as the passing orders 505 are given in the above-described order of smaller distance, as 1, 2, . . . .

In the constraint region data, as shown in FIG. 5A, the unit ID 501 of the unit at the start point of the main route is E001, the unit ID 501 of the branch unit which the main route passes first is E002, the unit ID 501 of the branch unit which the main route passes secondly is E003, and the unit ID 501 of the unit at the end point of the main route is E004. The coordinate values of the unit nozzle point 503 of the branch unit which the main route passes first are (x2, y2, z2) and the constraint distance 504 is 5000 mm, and the coordinate values of the unit nozzle point 503 of the branch unit which the main route passes secondly are (x3, y3, z3) and the constraint distance 504 is 7000 mm. When storing in the constraint region database 105 is completed, the entire process by the constraint region generating section 107 is terminated.

The flow of the generating process (S603) of a main route and branch routes by the constraint region generating section 107 will be described below.

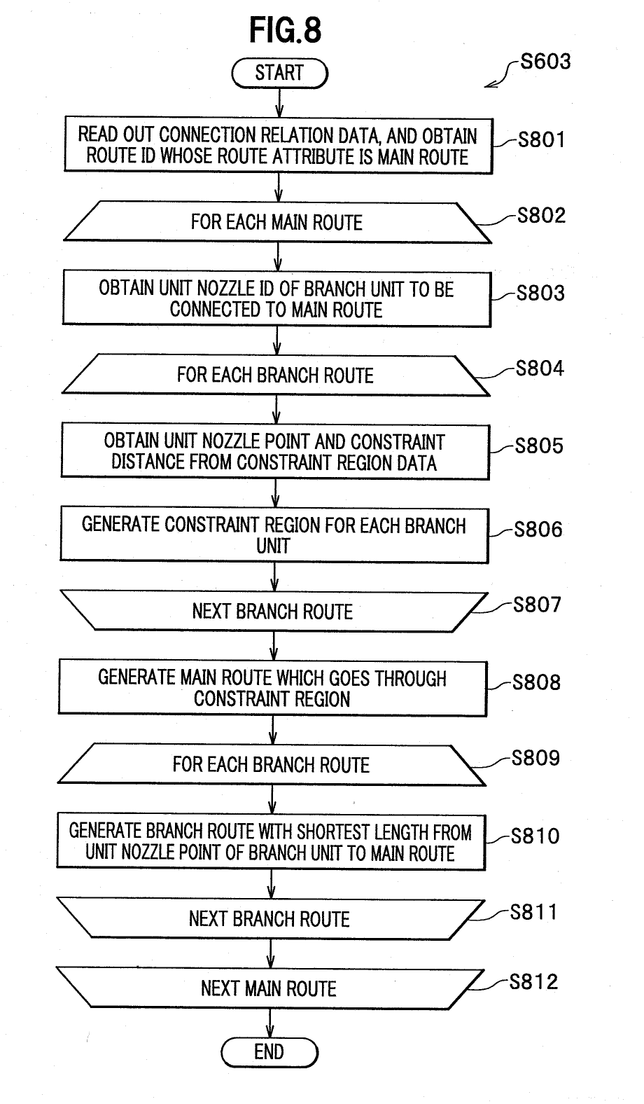

FIG. 8 shows a process flow of generating main routes and branch routes in the one embodiment according to the invention.

The route generating section 108 first reads out connection relation data from the connection relation database 103 (FIG. 3A), and obtains the route IDs 301 of routes whose route attribute 304 is main route (S801).

For each main route (the loop process in S802 to S812), the unit nozzle IDs of branch units to be connected to a main route are obtained from start-point connection object IDs 302 in the connection relation data (S803). From the connection relation data, as shown in FIG. 3A, L002 and L003 are obtained as the route IDs of these branch routes, and E002-N01 and E003-N01 are obtained as the unit nozzle IDs of the branch units.

Subsequently, for each of the read out branch route (the loop process shown in S804 to S807), the unit nozzle point 503 and the constraint distance 504 of the branch unit are obtained by a key of the unit nozzle ID of the branch unit from the constraint region data, as shown in FIG. 5A (S805).

Subsequently, a constraint region with a center at the unit nozzle point and a radius of the constraint distance is generated for each of the branch units (S806). In the constraint region data, as shown in FIG. 5A, for example, the constraint region of the branch unit whose unit ID 501 is E002 is a region 506 enclosed by a spherical surface with a center at the unit nozzle point (x2, y2, z2) whose unit nozzle ID is E002-N01 and a radius of 5000 mm.

After constraint regions related to all the branch routes to be connected to the main route are generated (S807), a main route is generated such that the main route goes, with the shortest distance, from the unit nozzle point of the unit as the start-point connection object of the main route, through the constraint regions generated for the respective branch units, to the unit nozzle point of the unit as the end-point connection object (S808). The method for generating the shortest route can be obtained from a shortest path search method, such as a maze algorithm.

In a shortest path search method, connection objects, the geometric shape of a building, the geometric shapes of routes having already been generated in the disposition data are recognized to be obstacles, and routes are assumed to be generated, avoiding these obstacles. With the constraint region data, as shown in FIG. 5A, for example, a main route 508 is generated to go from the unit nozzle E001-N01 as the start point, through the constraint region 506 of the branch unit with unit ID E002 and the constraint region 507 of the branch unit with unit ID E003, to the unit nozzle E004-N01 as the end point (refer to FIG. 5B).

Subsequently, as each branch route to be connected to the main route (the loop process from S809 to S811), a branch route with the shortest length from the unit nozzle point of a branch unit to the main route is generated (S810). The method for generating the shortest route can be obtained from a shortest path search method, such as a maze algorithm, similarly to the case of a main route. With the constraint region data, as shown in FIG. 5A, a shortest route 509 from the unit nozzle point E002-N01 to the main route 508, and a shortest route 510 from the unit nozzle point E003-N01 to the main route 508 are generated (refer to FIG. 5B).

After generating all respective branch routes to be connected to a main route (S811) and generating all main routes and respective branch routes (S812), the entire process by the route generating section 108 is terminated.

The flow of the display process (S604) performed by the constraint region and route display section 109 will be described below in detail.

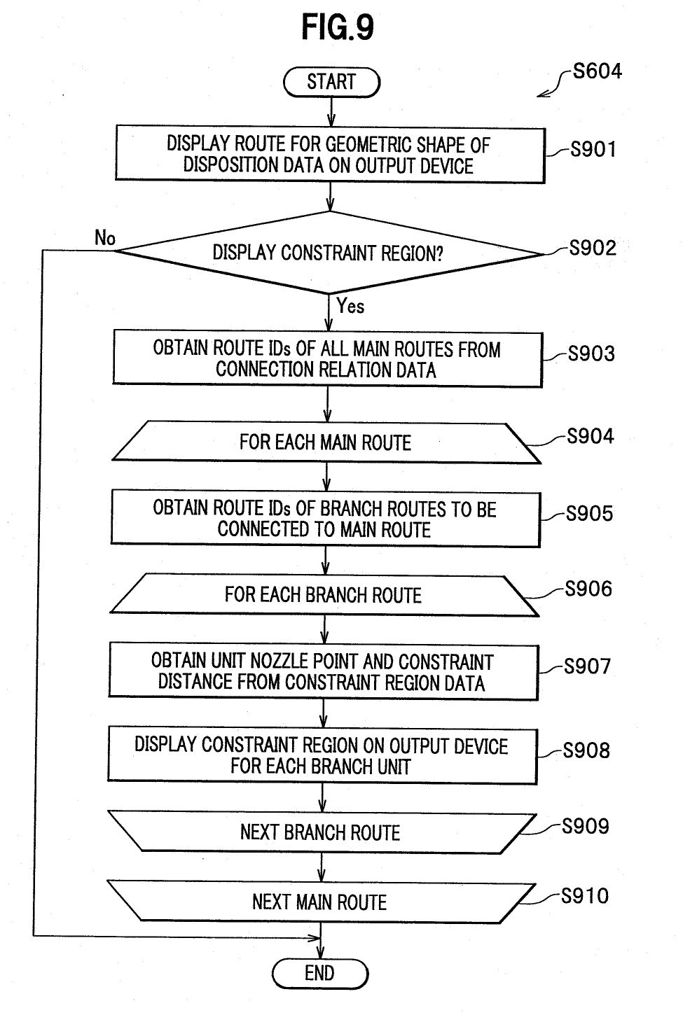

FIG. 9 shows a process flow of displaying routes and constraint regions in the one embodiment according to the invention.

The constraint region and route display section 109 first displays the routes generated by the route generating section 108 for the geometric shapes of the disposition data, namely, the main routes and the branch routes on the output device 111 (S901).

Depending on a request from the user via the input device 110, it is determined whether or not to display constraint regions. If it is determined not to display constraint regions, in other words, if such a request has not been made by the user (No in S902), the entire process in FIG. 9 is terminated. If an input is made to display constraint regions (Yes in S902), then the route IDs 301 of all the main routes are obtained from the connection relation data (refer to FIG. 3A) (S903).

For each obtained main route (the loop process in S904 to S910), the route IDs of branch routes to be connected to a main route are obtained (S905). This obtaining is achieved, based on that the values of the end-point connection objects ID 303 are the identifier of the corresponding main route.

For each of all branch routes to be connected a main route (the loop process in S906 to S909), the unit nozzle point 503 and the constraint distance 504 are obtained from the constraint region data (refer to FIG. 5A) (S907). This obtaining is achieved, based on that the value of the start-point connection object ID 303 is the nozzle identifier of the corresponding branch route.

A constraint region is displayed on the output device 111, based on the unit nozzle point and the constraint distance of each corresponding obtained branch route (S908).

After displaying constraint regions for all of branch routes to be connected to a main route (S909) and displaying constraint regions for all main routes (S910), the entire process performed by the constraint region and route display section 109 is terminated.

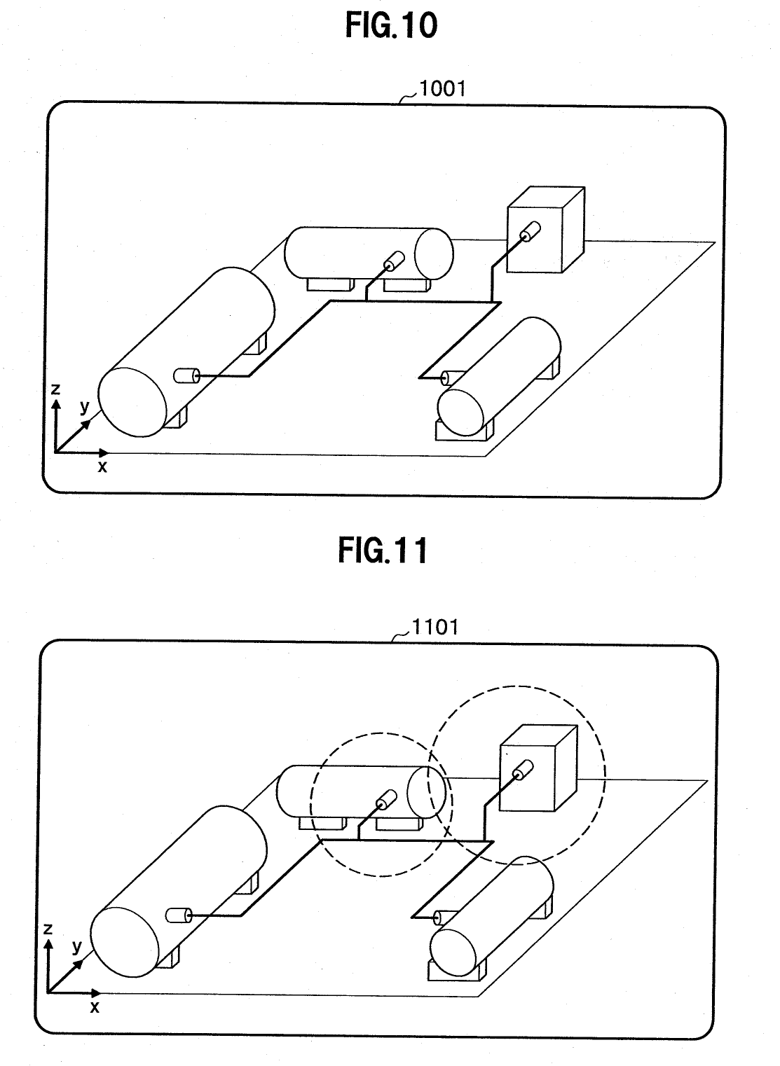

FIG. 10 shows an example of displaying routes in the one embodiment according to the invention. As the display example, a screen example 1001 is shown in which the constraint region and route display section 109 displays the geometric shape of disposition data, a main route, and branch routes as three-dimensional geometric shapes on the output device 111. In the present embodiment, in case that there are plural main routes and branch routes, a user may, for example, designate target routes via the input device 110 to display only the main routes, display only the branch routes, or display the main routes and the branch routes to be connected to the main routes together. In this case, the output device 111 preferably displays an interface that enables a user to select objects to be displayed.

FIG. 11 shows an example of displaying the constraint regions in the one embodiment according to the invention. As the display example, a screen example 1101 is shown in which the constraint region and route display section 109 displays the three-dimensional geometric shapes (spheres) of the constraint regions, superimposing them on the geometric shape of the disposition data and the geometric shapes of the main route and the branch routes on the output device 111. In the present embodiment, although dashed circles represent the spherical surfaces for brevity of representation in the figure, the three-dimensional geometric shapes of the constraint regions may be displayed by transparent spherical surfaces or spherical surfaces added with a certain degree of transparency. Further, only the constraint regions related to the branch routes connected with the main route may be displayed.

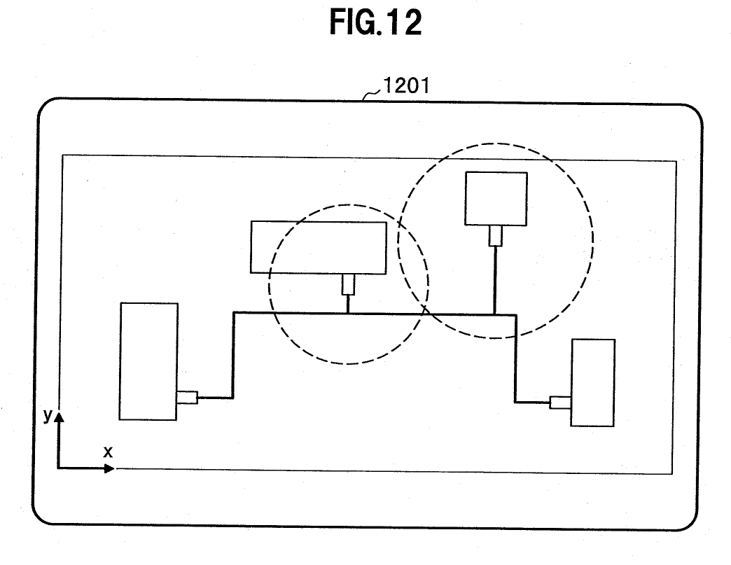

FIG. 12 shows another display example of the constraint regions in the one embodiment according to the invention. As the display example, a screen example 1201 is shown in which the constraint region and route display section 109 displays the two-dimensional geometric shapes (circles described with dashed line) of the constraint regions, superimposing them on the geometric shape of the disposition data and the geometric shapes of the main route and the branch routes on the output device 111. In the present embodiment, a display mode may be switched between the three-dimensional display 1101 and the two-dimensional display 1201.

According to the present embodiment, by defining in advance the design constraint of each branch unit by the constraint distance from the unit nozzle point of the branch unit, it is possible to efficiently generate a main route that passes through constraint regions where branch points can be disposed while confirming the constraint regions and the figure of the disposition data on the same screen.

Accordingly, for a main route and plural branch units for connecting connection objects, regions in which the branch points of the branch routes connected with the main route can be disposed are displayed visually for a designer, which enables the designer to design routes while confirming design constraints related to branch points, and reduces redesigning of routes.

### Second Embodiment

Another embodiment of a route generating apparatus according to the present invention will be described below.

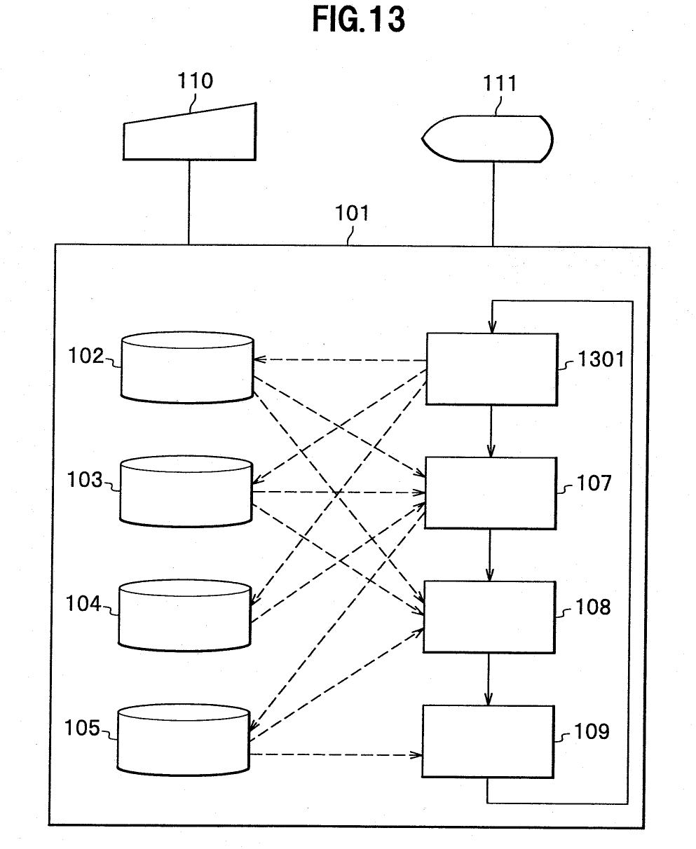

FIG. 13 shows a configuration of a route generating apparatus in another embodiment according to the present invention. The same symbols are assigned to the same elements as those in the first embodiment, and description thereof will be omitted.

The difference of the present embodiment from the first embodiment is that an editing section 1301 to which means for editing routes and design constraint data is added is provided in this embodiment.

The editing section 1301 modifies the geometric figure data of main routes and branch routes generated by the route generating section 108 and constraint regions generated by the constraint region generating section 107, upon receiving the moving destinations or disposition directions, of the figures, having been input by interactive operation via the input device 110. The geometric figures of routes may be edited in a state of displaying the geometric figure of constraint regions displayed by the constraint region and route display section 109.

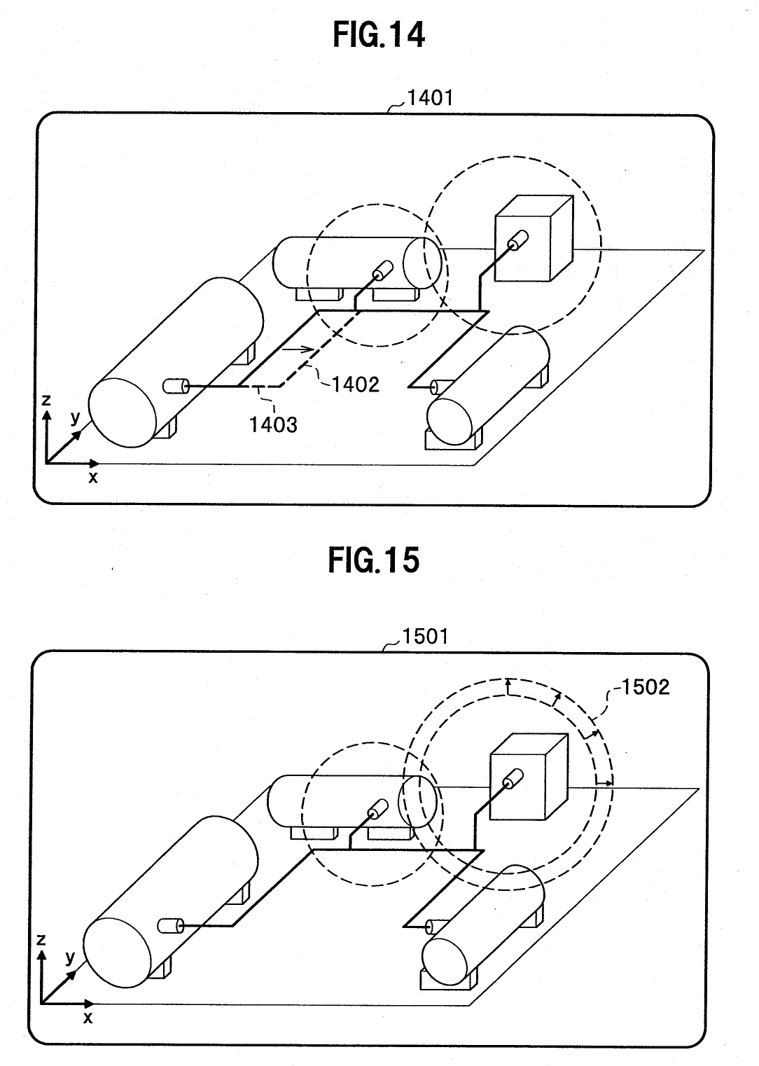

FIG. 14 shows an example of displaying an edit screen for routes. The display example 1401 is an example of parallel translation of one linear shape of a main route along x-axis. The editing section 1301 is assumed to recompute the end-point coordinate values of a linear shape 1403 adjacent to a translated linear shape 1402 such that the end-point coordinate values of the linear shape 1403 agree with the end-point coordinate values of the translated linear shape 1402, and thus modify the length of the linear shape adjacent to the translated linear shape, following the linear shape of the translated linear shape.

FIG. 15 shows an example of displaying an edit screen for constraint regions. A display example 1501 is an example of changing (increasing) the constraint distance of the constraint region 1502 of a certain branch unit by numerical input. The editing section 1301 updates the design constraint database 104, using the constraint distance of the modified constraint region. Upon the update of the design constraint database 104, the constraint region generating section 107 updates the constraint region database 105, based on the new constraint distance. Upon the update of the constraint region database 105, the route generating section 108 generates a new main route and branch routes passing through the constraint regions, and the constraint region and route display section 109 displays a result of the generation.

On the edit screen for constraint regions, a constraint distance may be modified by dragging a spherical surface representing a constraint region with a mouse. Corresponding to the modification, the design constraint database 104 and the constraint region database 105 are updated, as appropriate.

According to the present embodiment, a user can modify the figures of constraint regions related to a main route and branch routes while simultaneously confirming the routes, and routes based on modification can be efficiently regenerated, which reduces redesigning of routes.

### <Others>

Although the above-described embodiment is preferable for carrying out the invention, embodiments of the invention are not limited thereto, and various modifications and changes can be made without departing from the spirit of the invention.

For example, in case that the OS (Operating System) mounted on a computer, which is the route generating apparatus 101, is one that realizes a touch panel function of a display, the image of geometric shapes displayed on the output device (functioning also as the input device 110) may be processed, such that the respective databases (102, 103, 104, 105) are updated by touching the display to appropriately modify the shapes, the sizes, the colors, and the like of the lines representing main routes and branch routes, the spherical surfaces representing constraint regions, and the like.

Further, the passing order 505 in the constraint region database 105 in the present embodiment is set according to the order of closer distance from the nozzle at the start point of a unit. However, the ordering may be performed such that a passing order changes, depending on a value registered as a constraint distance 504. That is, when the constraint distance of a certain branch unit is increased or decreased, the orders of respective branch units may change upper or lower.

Further, designing of routes is performed basically after determining the dispositions of units, however, the software may be configured for the sake of designing such as to enable determining the state of dispositions and branching of routes first, and then designing the dispositions, the shapes, and the like of units.

Concrete configurations of hardware, software, and the like in other aspects can be modified and changed, as appropriate, within a range without departing from the spirit of the invention.

The invention is applicable to piping designing of a plant and the like in which piping designing of a number of main pipes and branch pipes is performed, based on design constraints, and also widely applicable to designing of wiring routes of an electronic circuit and the like.

What is claimed is:

1. A route generating apparatus for generating routes that connect connection objects, comprising:
a storage section that stores:
disposition data that represents geometric disposition positions of connection objects;
connection relation data that represents connection relations between each main route for directly connecting connection objects, each branch route that branches from the main route and connects with a connection object and the main route, and the connection objects; and
design constraint data which represents each constraint condition for constraining a disposition position of a branch point where the corresponding branch route branches from the corresponding main route;
a constraint region generating section that generates constraint region data which represents, for the each branch route, a constraint region where the corresponding branch point can be disposed, based on the geometric disposition position of the corresponding connection object represented by the disposition data, the corresponding connection relation represented by the connection relation data, and the corresponding constraint condition represented by the design constraint data;
a route generating section that generates, as the each main route, a shortest main route passing through the each constraint region corresponding to the each branch route connected with the main route, and generates, as the each branch route, a shortest branch route that branches from the main route; and
a constraint region and route display section that displays, on a display unit, a geometric figure representing the each constraint region and a geometric figure representing the each main route and the each branch route, superimposing the geometric figures or individually.

2. The route generating apparatus according to claim 1, wherein the constraint region and route display section displays, on the display unit, the geometric figure of the each constraint region, superimposing the geometric figure on a geometric figure of the connection objects.

3. The route generating apparatus according to claim 2, further comprising:
an edit section for editing the each main route and the each branch route generated by the route generating section, and the each constraint condition in the constraint region data,
wherein the constraint region and route display section displays, on the display unit, a geometric figure of the each main route and the each branch route having been edited by the edit section and a geometric figure of the each constraint region having been edited by the edit section, superimposing the geometric figures on the geometric figure of the connection objects.

4. A program for generating routes that makes a computer for generating routes which connect connection objects function as a route generating apparatus, wherein the program makes the route generating apparatus implemented by the computer to comprise the functions of:
a storage section that stores:
disposition data that represents geometric disposition positions of connection objects;
connection relation data that represents connection relations between each main route for directly connecting connection objects, each branch route that branches from the main route and connects with a connection object and the main route, and the connection objects; and
design constraint data which represents each constraint condition for constraining a disposition position of a branch point where the corresponding branch route branches from the corresponding main route;
a constraint region generating section that generates constraint region data which represents, for the each branch route, a constraint region where the corresponding branch point can be disposed, based on the geometric disposition position of the corresponding connection object represented by the disposition data, the corresponding connection relation represented by the connection relation data, and the corresponding constraint condition represented by the design constraint data;
a route generating section that generates, as the each main route, a shortest main route passing through the each constraint region corresponding to the each branch route connected with the main route, and generates, as the each branch route, a shortest branch route that branches from the main route; and
a constraint region and route display section that displays, on a display unit, a geometric figure representing the each constraint region and a geometric figure representing the each main route and the each branch route, superimposing the geometric figures or individually.

5. The program for generating routes according to claim 4,
wherein the constraint region and route display section displays, on the display unit, the geometric figure of the each constraint region and the geometric figure of the connection objects, superimposing the geometric figures.

6. The program for generating routes according to claim 5,
wherein the program further makes the route generating apparatus function as an edit section for editing the each main route and the each branch route generated by the route generating section and the each constraint condition in the constraint region data,
and wherein the constraint region and route display section displays, on the display unit, a geometric figure of the each main route and the each branch route having been edited by the edit section and a geometric figure of the each constraint region having been edited by the edit section, superimposing the geometric figures on the geometric figure of the connection objects.
